(19) United States
(12) Patent Application Publication
(10) Pub. No.: US 2005/0115155 A1
(43) Pub. Date: Jun. 2, 2005

(54) Door for a motor vehicle

(76) Inventors: Franco Ottino, Giuliano Terme (IT); Mario Cappelli, San Giuliano Terme (IT)

Correspondence Address: Robin W Asher;Clark Hill, 500 Woodward Avenue, Suite 3500, Detroit, MI, 48226-3435, US

(21) Appl. No.: 10/399,849

(22) PCT Filed: Oct. 22, 2001
(86) PCT No.: PCT/IT01/00532

(30) Foreign Application Priority Data
Oct. 20, 2000 (IT) T02000A000995

(51) Int. Cl. B60J 5/04

(52) U.S. Cl. 49/502

(57) ABSTRACT

A door (1, 70) for a motor vehicle has a supporting skeleton (2) provided with an upper frame forming a window, and a lower box-shaped portion (5) forming an inner compartment (9) which houses a window regulator (37, 77) for moving a window pane (3) which closes the window. The window regulator (37, 77) is joined to the panel (14, 74) at least in a temporary way by means of positioning and support devices (25, 27, 78, 26) to form an assembly module (61, 71), which is connected integrally to the box-shaped portion (5) by means of fixing elements (16, 26, 79).

### TECHNICAL FIELD

The present invention relates to a door for a motor vehicle.

### BACKGROUND ART

As is known, the side door of a motor vehicle comprises a metal skeleton which in turn comprises an upper frame which delimits a window which can be closed by a sliding window pane, and a lower box-shaped portion formed by an inner wall and an outer wall joined together along an edge. The inner and outer walls delimit between them a compartment which houses the window pane when it is lowered, and certain operating and control devices, such as the window regulator device and the lock of the door.

During the assembly of the door, these devices are inserted into the compartment through corresponding apertures formed in part of the surface of the inner wall, and are connected integrally to the skeleton. Subsequently, these apertures are closed by means of a shaped trim panel which is generally made from plastic material and is joined integrally to the inner wall to delimit the passenger compartment of the motor vehicle.

The doors of the known type described above are unsatisfactory in terms of assembly time and costs, since it is relatively inconvenient to insert the various devices into the apertures of the inner wall and permanently connect the devices to the skeleton by operating through these apertures.

To overcome these disadvantages, there is a known way of making a module which comprises a supporting panel, generally made from plastic material, and the various operating and control devices, which are connected integrally to the supporting panel. During the assembly of the door, the module is pre-assembled and then conveyed to a station where it is connected integrally to a skeleton which normally does not have the inner wall.

The doors of the known type described above have the disadvantage that the supporting panel is relatively complex, bulky and expensive, since it must be more rigid than the trim panels of the conventional type in order to support the operating and control devices without becoming deformed in transit from one station of the assembly line to another.

### DISCLOSURE OF INVENTION

The object of the present invention is to provide a door for a motor vehicle which enables the above problems to be overcome in a simple and economical way, and, in particular, makes it possible to simplify the assembly of at least the window regulator device by using a trim panel of the conventional type.

According to the present invention, a door for a motor vehicle is provided, comprising a supporting skeleton comprising a frame forming a window and a box-shaped portion forming an inner compartment and comprising an outer wall and an inner wall, and a window regulator device housed in the compartment and capable of moving a window pane for closing the window. The inner wall has at least one aperture formed in part of its surface for fitting the window regulator device into the compartment. This aperture is covered by a trim panel connected integrally to the box-shaped portion. An assembly module comprises the window regulator device, the trim panel, and means of relative positioning and support to join the window regulator device, at least in a temporary way, to the trim panel. Fixing elements are provided to connect the assembly module integrally to the box-shaped portion.

### BRIEF DESCRIPTION OF THE DRAWINGS

The invention will now be described with reference to the attached drawings, which illustrate a non-restrictive example of embodiment of the invention, in which:

FIG. 1 shows, partially and in lateral elevation, a first preferred embodiment of the door for a motor vehicle made according to the present invention;

FIGS. 2 and 3 show corresponding details of the door of FIG. 1;

FIGS. 4 and 5 are sections, on an enlarged scale and with parts removed for the sake of clarity, taken along the line IV-IV and the line V-V respectively in FIG. 1;

FIGS. 6, 7 and 8 are figures similar to FIGS. 1, 2 and 3 respectively, illustrating a second preferred embodiment of the door for a motor vehicle made according to the present invention;

FIG. 9 is a section, on an enlarged scale and with parts removed for the sake of clarity, taken along the line IX-IX in FIG. 8; and

FIG. 10 is a section, with parts removed for the sake of clarity, taken along the line X-X in FIG. 6.

### BEST MODE FOR CARRYING OUT THE INVENTION

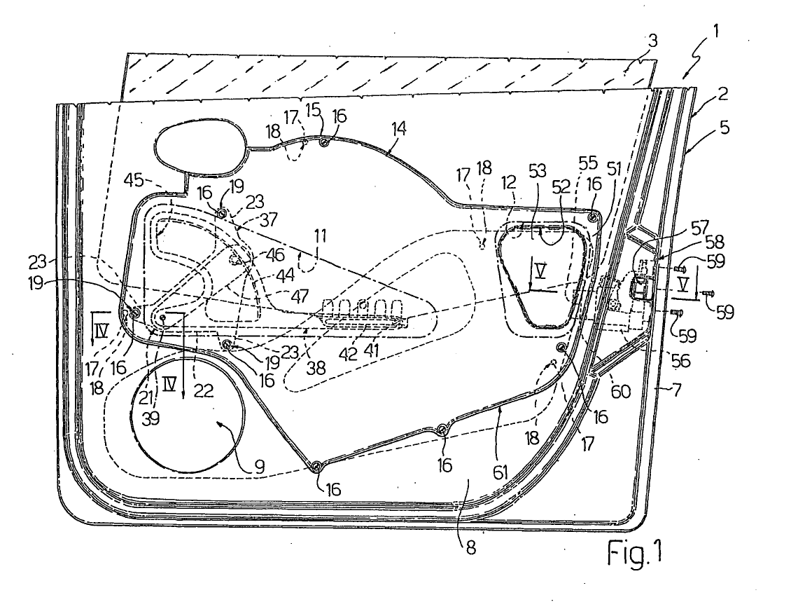

In FIG. 1, the number 1 indicates, as a whole, a side door for a motor vehicle (not illustrated), this door comprising a metal supporting skeleton 2 (partially illustrated) of a known type, which in turn comprises an upper frame (not illustrated) delimiting a window which can be closed by a movable window pane 3.

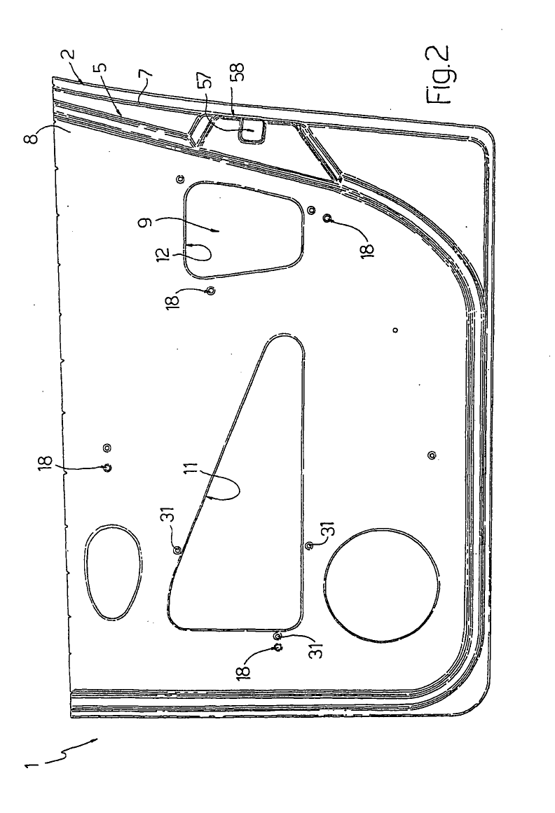

With reference to FIGS. 1 and 2, the skeleton 2 also comprises a lower box-shaped portion 5 formed by two walls 7 and 8 or sheets opposite each other, which face the interior and exterior of the motor vehicle respectively, and which are joined together along the perimetric edge of the wall 8. The walls 7 and 8 delimit between them an inner compartment 9, which houses a window pane 3, at least when the window pane 3 is lowered, and has a plurality of access apertures formed in part of the surface of the wall 8 and, in particular, an essentially triangular aperture 11 and an essentially trapezoidal aperture 12 (shown in dashed lines in FIG. 1).

With reference to FIGS. 1 to 5, the apertures 11 and 12 are closed by a shaped trim panel 14 (FIGS. 1 and 3) which partially covers the wall 8 externally and delimits the passenger compartment of the motor vehicle, and is made in one piece, preferably by moulding from a plastic material.

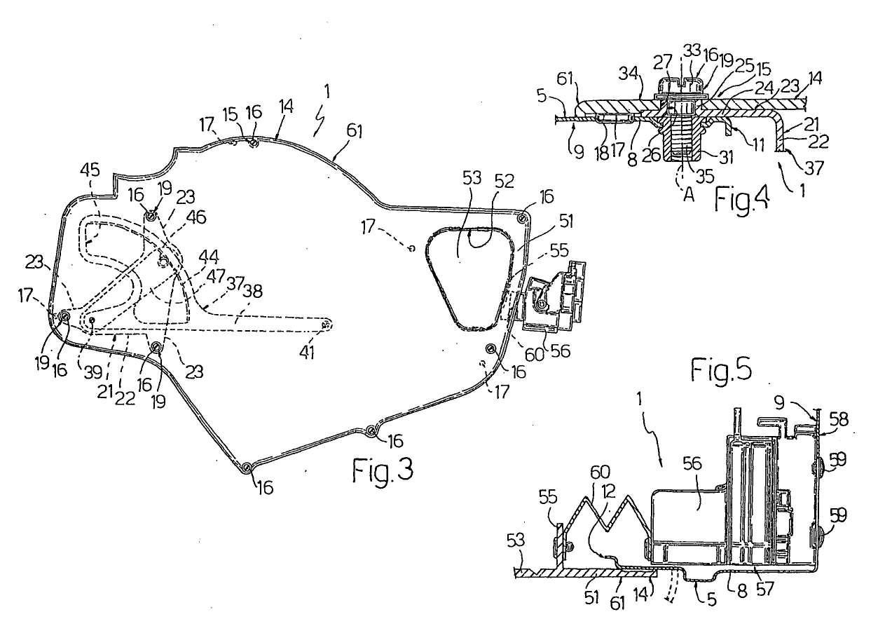

The wall 8 and the panel 14 are joined together by a connecting system 15 which comprises a plurality of screws 16 located along a perimetric portion of the panel 14, and a plurality of centring portions 17 formed in one piece with the panel 14 and engaging in corresponding reference seats 18 formed in the wall 8 (FIG. 4).

The system 15 comprises three joining devices 19 for connecting integrally and also providing fastening points to the wall 8, the panel 14 and a plate 21, which comprises an intermediate portion 22 with an essentially triangular profile extending through the aperture 11, and three terminal fastening appendages 23.

Each of the appendages 23 comprises a flattened annular portion 24 parallel to, and interposed between, the wall 8 and the panel 14 along the periphery of the aperture 11, and an intermediate stud 25, which projects from the corresponding portion 24 along an axis A orthogonal to the portion 24, is shaped in the form of a collar to form a corresponding axial through hole 26, and engages in a through seat 27 formed through the panel 14.

Each stud 25 and the corresponding seat 27 form part of a device 19, which additionally comprises an internally threaded nut 31 connected integrally to the wall 8 and coaxially with the corresponding stud 25, and one of the screws 16 comprising a head 33 bearing on an outer surface 34 of the panel 14, and a threaded shank 35 engaging in the corresponding hole 26 and locked by the corresponding nut 31.

With reference to FIG. 1, the plate 21 forms part of a window regulator device 37, shown schematically, which is housed in the compartment 9 and comprises an arm 38 for moving the window pane 3, this arm being hinged, at one end, to the portion 22 so that it rotates about an axis 39 which is essentially orthogonal to the walls 7 and 8 and to the plane of FIGS. 1 and 3. The arm 38 has an integral pushing stud 41 projecting from its other end, parallel to the axis 39, and coupled slidably to an essentially horizontal rectilinear guide 42 fixed to the base of the window pane 3. The arm 38 comprises a sector 44, which extends about the axis 39 in an intermediate position between the ends of the arm 38, delimits a slot 45, is internally toothed, and engages with a pinion 46 driven by a gear motor unit 47 (shown schematically). The unit 47 is operated to rotate the arm 38 and thus to raise or lower the window pane 3, and comprises, in the particular example described, an electric motor and a transmission of the worm and helical gear type.

With reference to FIGS. 1 and 3, the panel 14 comprises a terminal portion 51, at the opposite end to the device 37, and an intermediate aperture 52 which provides access to the aperture 12 and is closed by a snap-on hatch 53, which is made in one piece with the panel 14 and is joined to the portion 51 by means of a virtual hinge.

With reference to FIGS. 1, 3 and 5, a bracket 55 extends in one piece from the portion 51 and projects into the compartment 9 through the aperture 12, and carries a lock 56 housed in a terminal area 57 of the compartment 9 delimited by a rear side 58 of the box-shaped portion 5. The lock 56 is fixed to the side 58 by means of a pair of screws 59 and is joined to the bracket 55 with the interposition of an elastic element 60, preferably accordion-shaped, which allows the lock 56 to move with respect to the panel 14 in a plane which is essentially horizontal and orthogonal to the portion 51. In a variant which is not illustrated, the element 60 is made in one piece with the bracket 55 and therefore with the panel 14.

During the assembly of the door 1, after the skeleton 2 has been assembled, the lock 56 is connected to the bracket 55, while the fastening plate 21 of the device 37 is joined movably to the panel 14 by the forcing of the studs 25 into the corresponding seats 27. Thus the plate 21 is placed in a fixed position with respect to the panel 14 and supported, in a temporary way, by the panel 14 during the assembly, thus forming a pre-assembled module 61 comprising the panel 14, the device 37 and the lock 56.

At the same assembly station, the module 61 is placed in a position facing the wall 8 and is then joined to the box-shaped portion 5 by insertion of the lock 56 into the aperture 12 and movement of the module 61 with respect to the skeleton 2 in an essentially horizontal direction from the left to the right with reference to FIGS. 1 to 3, in such a way that the lock 56 is introduced into the rear area 57 of the compartment 9. The device 37 is then inserted through the aperture 11, while the module 61 continues to be moved in the aforesaid direction, until the lock 56 bears against the side 58, and until the stud 41 moves beyond the guide 42, compressing the elastic element 60 if necessary. At this point, the module 61 is made to withdraw horizontally towards the left so that the stud 41 is made to enter the guide 42, and is placed in a fixed position with respect to the wall 8 by insertion of the centring portions 17 into the corresponding reference seats 18.

Finally, the screws 16 are screwed in to secure the module 61 to the wall 8, and the lock 56 is positioned manually through the apertures 52 and 12 in such a way that the screws 59 can be tightened through the side 58, by working from the exterior of the door 1.

Finally, the hatch 53 is closed, and other trim panels (not illustrated) are applied to completely cover the wall 8, providing fluid-tight joints between the panels and the skeleton 2.

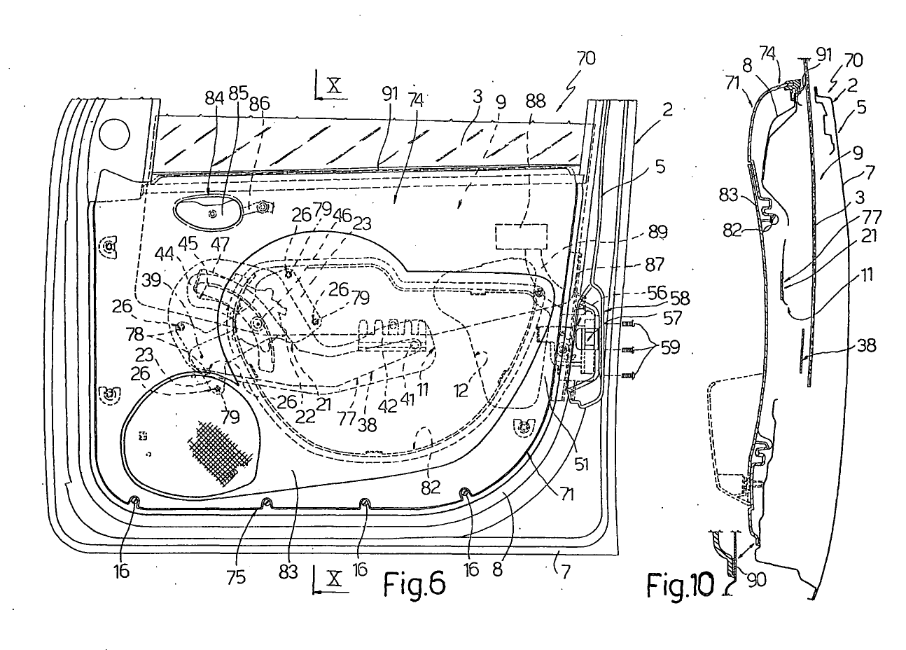

FIGS. 6 to 10 show a door 70 whose components are identified, where possible, by the same reference numbers as those used for the corresponding parts of the door 1.

The wall 8 is joined to a module 71 comprising a trim panel 74 which has constructional characteristics similar to those of the panel 14, faces the wall 8 and is joined to the box-shaped portion 5 by a connecting system 75 comprising the screws 16 and a set of centring portions (not illustrated) interacting with the wall 8. The module 71 comprises the lock 56 and a window regulator device 77 (FIGS. 6, 8), which differs from the device 37 in the different shape of the plate 21 and the arm 38 and in that it has no collar-shaped portions 26, while the holes 26 are delimited by the portions 24.

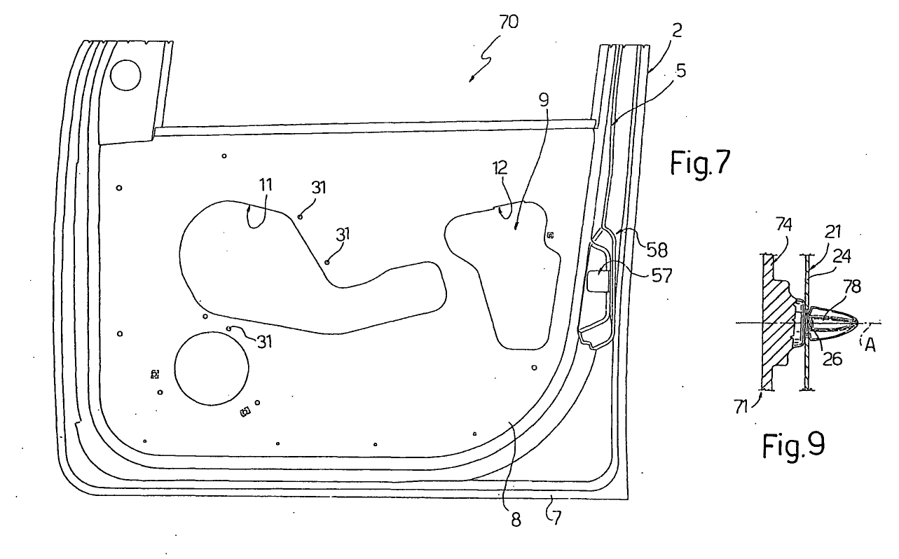

The device 77 is carried by the panel 74 in a temporary way by means of a pair of studs 78 (FIG. 9), which are made in one piece with the panel 74, project along corresponding axes A towards the wall 8, and are snap-fitted into corresponding holes 26 formed in one of the appendages 23 of the plate 21. In a variant which is not illustrated, the studs 78 are separate from the panel 74 and from the plate 21, and are connected integrally to the panel 74. The plate 21 is connected integrally to the box-shaped portion 5 by means of three fixing screws 79, which engage in corresponding holes 26 and are screwed into corresponding nuts 31 (FIG. 7) which are integral with the wall 8, to secure the appendages 23.

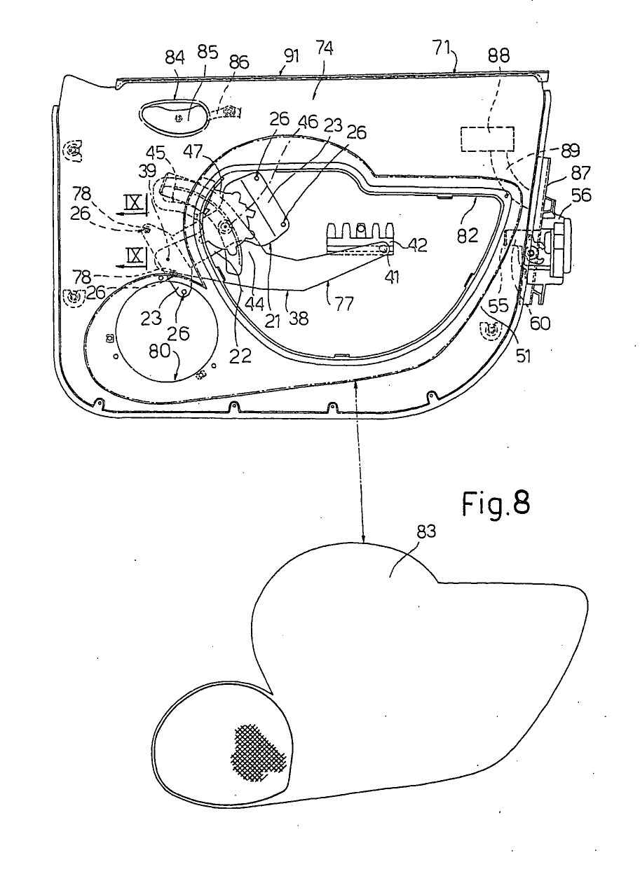

In the panel 74 there are formed an aperture 80 for a loudspeaker (not illustrated) which can be housed in the compartment 9, and an intermediate aperture 82, which has dimensions greater than those of the aperture 52 of the panel 14, provides access both to the device 72 and to the lock 56 through the apertures 11 and 12, and is closed by a panel 83 (FIGS. 8, 10) connected releasably to the panel 74, preferably by a snap-fitting method. The panel 83 delimits the passenger compartment together with the panel 74, and is covered externally with fabric or other finishing material with a pleasing appearance.

With reference to FIGS. 6 and 8, the module 71 comprises an interior handle 84 which is carried directly by the panel 74 and which, in turn, comprises a lever 85, which can be operated from inside the passenger compartment to operate the lock 56 and is connected to the lock 56 by a lever mechanism 86 (partially illustrated) interposed between the panel 74 and the wall 8.

Also with reference to FIGS. 6 and 8, the module 71 comprises a guide 87 which enables the window pane 3 to slide in the compartment 9 and is carried by the panel 74 by means of the lock 56, to which it is connected integrally, preferably by a snap fitting.

The module 71 also comprises electrical wiring (not illustrated) connected to the electrical system of the motor vehicle and certain elements 88 (shown schematically) which form the inner parts of an outer handle of the door 70. These elements 88 are housed in the compartment 9 and comprise, in particular, a protective or anti-theft wall carried by the guide 87, the lock operating lever mechanisms 56 and a drum or block for a key to open the door 70, connected to the guide 87 by means of an elastic bracket 89, which projects from the guide 87 on the side opposite the lock 56.

With reference to FIG. 10, the module 71 comprises, finally, sealing elements 90 for excluding water and dust, interposed between the panel 74 and the wall 8, and a gasket element 91, commonly known as a “window seal”, connected integrally to the panel 74 in a position facing the window pane 3 and delimiting the window of the door 70 to interact by sliding with the window pane 3.

With reference to FIGS. 6 to 10, during the assembly of the door 70, by contrast with the assembly of the door 1, the plate 21 is snap-fitted to the studs 78, which have a rigidity and resistance such that the device 77 is supported at least in a temporary way, in other words such that the device 77 is kept joined to the panel 74 at least for the time required for the module 77 to be positioned against the wall 8, by operations carried out at the same assembly station.

The module 71 is initially joined to the box-shaped portion 5 by the insertion of the bracket 89 and the elements 88 into the aperture 12, followed by the insertion of the lock 56, by means of a slight rotation of the module 71 in the anti-clockwise direction according to FIGS. 6 to 8, so that the lock 56 is positioned in the area 57.

The module 71 is then simply pushed towards the wall 8 in order to insert the arm 38 into the aperture 11 and to position the appendages 23 so that they bear against the wall 8. The panel 74 is positioned on the wall 8 by means of the centring portions, and the screws 16 and 79 are then tightened to secure the panel 74 and the device 77 to the wall 8. Finally, by operations carried out from outside the box-shaped portion 5, the lock 56 is fixed to the side 58 by means of the screws 59, the elements 88 are secured to the wall 7 by means of screws which are not illustrated, and the window pane 3 is made to slide into the compartment 9 along the guide 87 until the edge of the window pane 3 is snap-fitted into the guide 42.

On completion of the assembly operations, the panel 83 is fitted to close the apertures 80, 82.

It will be clear from the above that the devices 19 and the studs 78 make it extremely simple to fit the device 37 to the door 1 by using trim panels 14, 74 of the conventional type, in other words those having a pleasing appearance and not having any special stiffening portions.

In particular, the studs 25 and the seats 27 for the door 1 and the studs 78 and the holes 26 for the door 70 enable the plate 21 to be placed in a fixed reference position with respect to the panel 14 and to connect the plate 21 to the panel 14, at least in a temporary way, during assembly. The assembly operations are therefore simplified by comparison with the known solutions, since the modules 61, 71 make it possible to eliminate manual operations through the aperture 11 for positioning and connecting the window regulator devices 37, 77 in the compartment 9.

At the same time, the modules 61, 71 make it possible to use a skeleton 2 of conventional type, in other words one which has a structure, a rigidity, and apertures 11 and 12 of the wall 8 which are identical to those of the skeletons normally used and which have apertures formed in only a part of the surface of the wall 8.

Moreover, the fact that the pre-assembled modules 61, 71 comprise other devices carried by the panels 14, 74, and in particular the lock 56, the handle 84, the guide 87 and the elements 88, further simplifies the operations of assembling the doors 1, 70, since, by contrast with the known solutions, these devices are placed in the corresponding positions in the compartment 9 by a single assembly operation, instead of being fitted one after another, and do not require the use of complex fitting equipment. As regards the lock 56, the apertures 12 and 52, 82 are used only for positioning, while the fixing of the lock 56 is carried out by working from the outside of the compartment 9.

Furthermore, the elasticity of the studs 78, of the element 60 and of the bracket 89 makes it possible to compensate automatically, on the one hand, the thermal deformations of the components of the door 1, 70, and, on the other hand, relatively minor errors of machining and/or positioning of the components.

With reference to the door 70, since the fastening points formed by the studs 78 are independent of the fastening points formed by the fixing screws 79, the reactive forces caused by the operation of the device 77 are discharged directly to the skeleton 2 and not to the panel 74, which is therefore not subject to displacement, deformation or vibration when in use.

Moreover, the module 71 also provides the panel 74 with a water and dust seal function with respect to the box-shaped portion 5 and the window pane 3, and enables the window pane 3 to be fitted in an extremely simple way, without the need to make complex adjustments of the position of the guide 87 with respect to the device 77, since both the guide 87 and the device 77 are carried by the panel 74 and placed in fixed relative positions.

Additionally, the possibility of removing the panel 83, which forms a kind of “plug” for the aperture 82, enables all the devices carried by the panel 74 to be inspected without the complete dismantling of the module 71, while the components of the door 74 can be dismantled in a simple way by disengaging the snap fittings through the aperture 82. In particular, the device 77 can be disconnected from the door 70 simply by slackening the screws 79 and disengaging the studs 78 from the holes 78.

Finally, it is clear from the above that modifications and variations can be applied to the described door 1, 70 without departure from the scope of protection of the present invention.

In particular, the window regulator device could be different from that described, and/or the functions of support and relative positioning between the plate 21 and the panel 14 could be at least partially provided by the screws 16 of the devices 19.

1. A door (1, 70) for a motor vehicle, comprising a supporting skeleton (2) comprising a frame forming a window and a box-shaped portion (5) forming an inner compartment (9) and comprising an outer wall (7) and an inner wall (8); a window regulator device (37, 77) housed in said compartment (9) and capable of moving a window pane (3) for closing said window, said inner wall (8) having at least one aperture (11, 12) formed in part of its surface for fitting said window regulator device (37, 77) into said compartment (9) and covered by a trim panel (14, 74) connected integrally to said box-shaped portion (5); characterized by comprising an assembly module (61, 71) in turn comprising said window regulator device (37, 77), said trim panel (17, 74), and means of relative positioning and support (25, 27, 78, 26) to join said window regulator device (37, 77), at least in a temporary way, to said trim panel (14, 74); fixing elements (16, 26, 79) being provided to connect said assembly module (61, 71) integrally to said box-shaped portion (5).

2. A door according to claim 1, characterized in that said means of relative positioning and support (25, 27, 78, 26) comprise at least one pair of studs (25, 78) carried by one of said trim panels (14, 74) and said window regulator device (37, 77), and, for each said stud (25, 78), a corresponding seat (27, 26) formed in the other of said trim panel (14, 74) and said window regulator device (37, 77) and engaged by said stud (25, 78).

3. A door according to claim 2, characterized in that said studs (25, 78) are forced into said corresponding seats (27, 26).

4. A door according to claim 3, characterized in that said fixing elements (16) and means of relative positioning and support (25, 27) are coaxial with each other.

5. A door according to claim 4, characterized in that said studs (25) are carried by said window regulator device (37) and have corresponding through holes (26) engaged by said corresponding fixing elements (16).

6. A door according to claim 5, characterized in that said studs (78) are independent of said fixing elements (16, 79).

7. A door according to claim 6, characterized in that studs (78) are integral with said trim panel (74).

8. A door according to claim 7, characterized in that said trim panel (74) comprises an intermediate passage (82) for access to said aperture (11, 12) and in that it comprises a trim wall (83) to releasably close said intermediate passage (82).

9. A door according to claim 8, characterized in that said assembly module (61, 71) comprises a lock (56) housed in said compartment (9) and means (55, 60) of connecting said lock (56) to said trim panel (14, 74).

10. A door according to claim 9, characterized in that said connecting means (55, 60) comprise elastic means (60) enabling said lock (56) to move with respect to said trim panel (14, 74); and tightening means (59) being provided to secure said lock (56) to said skeleton (2) from the outside.

11. A door according to claim 10, characterized in that said assembly module (71) also comprises a guide (87) for the sliding of said window pane (3) carried by said trim panel (74).

12. A door according to claim 11, characterized in that said guide (87) is snap-fitted to said lock (56).

13. A door according to claim 12, characterized in that said assembly module (71) also comprises elements (88) which form part of an exterior handle of said door (70) and are carried by said trim panel (74).

14. A door according to claim 13, characterized in that it comprises elastic means (89) of connecting at least some of said elements (88) to said guide (87).

15. A door according to claim 14, characterized in that said assembly module (71) comprises an interior handle (84) carried by said trim panel (74).

16. A door according to claim 15, characterized in that said assembly module (71) comprises sealing elements (90, 91) carried by said trim panel (74).

17. An assembly module (61, 71) for a vehicle door, said assembly module comprising a window regulator device (37, 77), a trim panel (14, 74), means of relative positioning and support (25, 27, 78, 26) to join said window regulator device (37, 77), at least in a temporary way, to said trim panel (14, 74); fixing elements (16, 26, 79) for connecting said assembly module (61, 71) integrally to a box-shaped portion (5) of the vehicle door.

18. (canceled)
